(19) United States
(12) Patent Application Publication
(10) Pub. No.: US 2023/0263127 A1
(43) Pub. Date: Aug. 24, 2023

(54) Animal Containment And Transport Assembly And Method Of Use

(71) Applicant: Robert Rivas, San Diego, CA (US)

(72) Inventor: Robert Rivas, San Diego, CA (US)

(21) Appl. No.: 17/678,133

(22) Filed: Feb. 23, 2022

(51) Int. Cl. A01K 1/02; A01K 1/00

(52) U.S. Cl. CPC A01K 1/0272; A01K 1/0058

(57) ABSTRACT

An animal containment and transport assembly for transporting a pet includes a housing and a pair of covers. A top of the housing is open. The covers are hingedly engaged to the housing and are positioned to selectively close the top. The housing and the pair of covers thus define an interior space that can contain an animal. The covers are selectively engageable to the housing so that the covers are fixedly positioned over the top. A plurality of wheels is engaged to a bottom of the housing. A pull handle is engaged to and is selectively extensible from the housing. The pull handle can be grasped in a hand of a user, positioning the user to pull on the pull handle to locomote the housing across a surface.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING

SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

The disclosure relates to animal containment assemblies and more particularly pertains to a new animal containment assembly for transporting a pet. The present invention discloses an animal containment assembly comprising a wheeled housing with an open top that is closable by a pair of hinged covers, and which has an extendable handle for pulling the animal containment assembly across a surface.

### (2) Description of Related Art including information disclosed under 37 CFR 1.97 and 1.98.

The prior art relates to animal containment assemblies. Prior art animal containment assemblies generally comprise substantially cuboid housings with a gated opening at one end. The housings may have wheels and handles. The housings also may be collapsible or comprise two separable and nestable sections. What is lacking in the prior art is an animal containment assembly comprising a wheeled housing with an open top that is closable by a pair of hinged covers, and which has an extendable handle for pulling the animal containment assembly across a surface.

### BRIEF SUMMARY OF THE INVENTION

An embodiment of the disclosure meets the needs presented above by generally comprising a housing and a pair of covers. A top of the housing is open. The covers are hingedly engaged to the housing and are positioned to selectively close the top. The housing and the pair of covers thus define an interior space that is configured to contain an animal. The covers are selectively engageable to the housing so that the covers are fixedly positioned over the top. A plurality of wheels is engaged to a bottom of the housing. A pull handle is engaged to and is selectively extensible from the housing. The pull handle is configured to be grasped in a hand of a user, positioning the user to pull on the pull handle to locomote the housing across a surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of an animal containment and transport assembly according to an embodiment of the disclosure.

FIG. 2 is a side view of an embodiment of the disclosure.

FIG. 3 is a front view of an embodiment of the disclosure.

FIG. 4 is a rear view of an embodiment of the disclosure.

FIG. 5 is a bottom view of an embodiment of the disclosure.

FIG. 6 is a flow diagram for a method utilizing an embodiment of the disclosure.

### DETAILED DESCRIPTION OF THE INVENTION

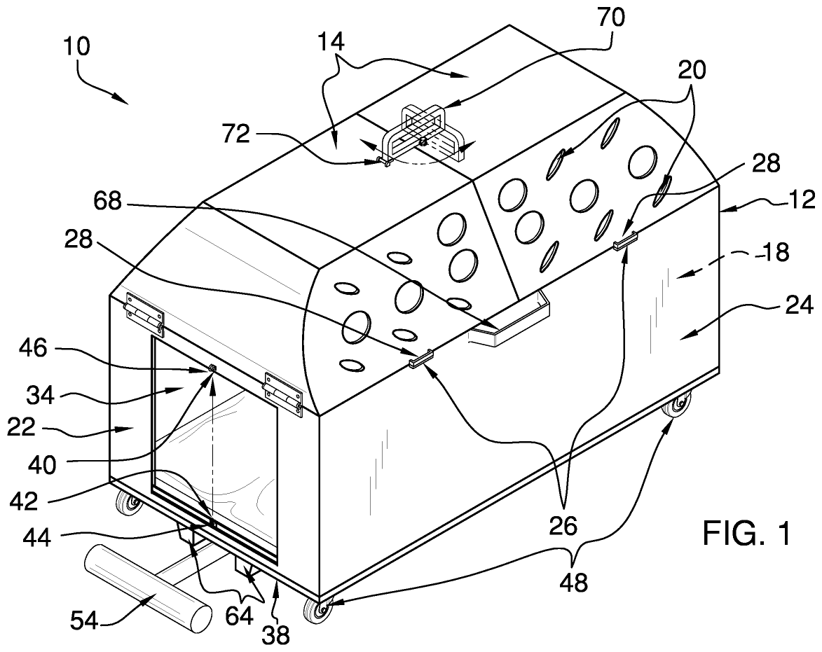

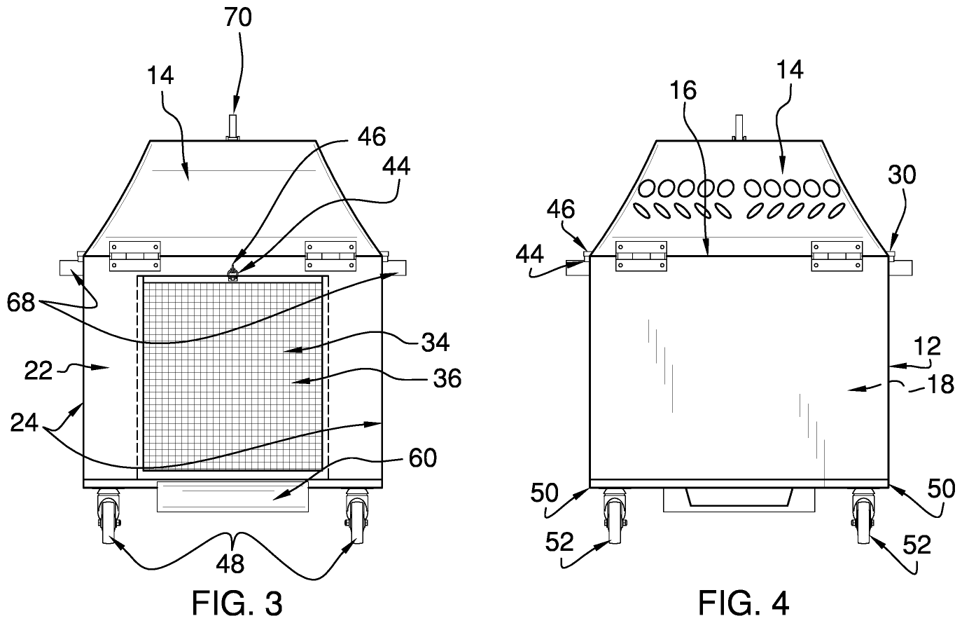

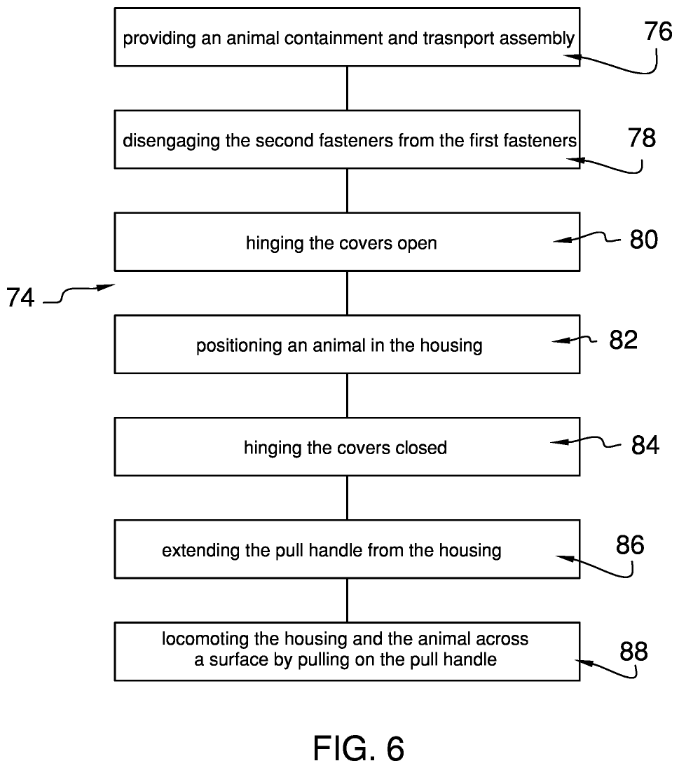

With reference now to the drawings, and in particular to FIGS. 1 through 6 thereof, a new animal containment assembly embodying the principles and concepts of an embodiment of the disclosure and generally designated by the reference numeral 10 will be described.

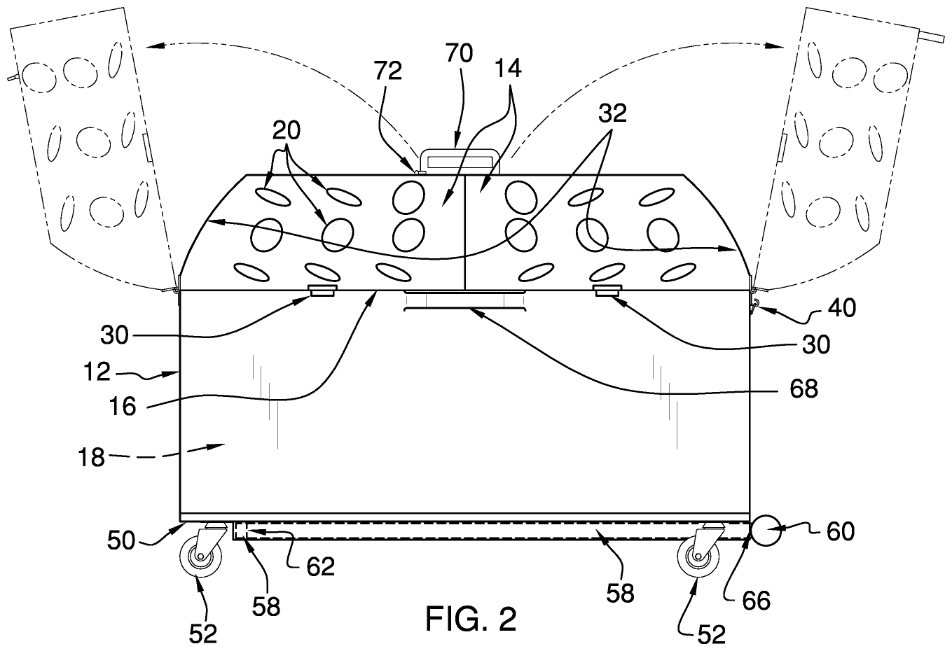

As best illustrated in FIGS. 1 through 6, the animal containment and transport assembly 10 generally comprises a housing 12 and a pair of covers 14. A top 16 of the housing 12 is open. The covers 14 are hingedly engaged to the housing 12 and are positioned to selectively close the top 16. The housing 12 and the pair of covers 14 thus define an interior space 18 that is configured to contain an animal, such as a dog or a cat. A plurality of apertures 20 is positioned in the pair of covers 14. The apertures 20 are configured to vent the interior space 18, thus providing air circulation to the animal contained in the interior space 18. The covers 14 are selectively engageable to the housing 12 so that the covers 14 are fixedly positioned over the top 16. As shown in FIG. 2, each cover 14 is hingedly engaged to a respective opposed end 22 of the housing 12. The present invention also anticipates each cover 14 being hingedly engaged to a respective opposed side 24 of the housing 12.

A plurality of first fasteners 26 engaged to the housing 12. A plurality of second fasteners 28 is engaged to the pair of covers 14. The second fasteners 28 are complementary to the first fasteners 26 so that each second fastener 28 selectively engages a respective first fastener 26 as the covers 14 are hinged closed to fixedly engage the pair of covers 14 to the housing 12. The second fastener 28 and the respective first fastener 26 may comprise a latch closure 30, or other closing means, such as, but not limited to, toggle clamps, cam closures, and the like.

The housing 12 may be substantially rectangular cuboid shaped, as shown in FIG. 2. The pair of covers 14 may be substantially rectangular frustum shaped when closed over the top 16. Opposing end facets 32 of the pair of covers 14 may be concavely arcuate when viewed from the interior space 18. The present invention also anticipate the housing 12 and the covers 14 being alternatively shaped.

An opening 34 is positioned in a respective opposed end 22 of the housing 12. A screen 36 is slidably engaged to the housing 12 so that the screen 36 is positioned to selectively cover 14 the opening 34. The screen 36 may be extensible from a bottom 38 of the housing 12 toward the top 16 of the housing 12, although the present invention also anticipates the screen 36 sliding toward the bottom 38 or toward either of the opposed sides 24 of the housing 12.

A first connector 40 is engaged to the housing 12. A second connector 42 is engaged to the screen 36 so that second connector 42 is positioned to selectively engage the first connector 40 upon extension of the screen 36 over the opening 34 to retain the screen 36 in position over the opening 34. The second connector 42 may comprise a ring 44 and the first connector 40 may comprise a hook 46. The present invention also anticipate the first connector 40 and the second connector 42 comprising other connecting means, such as, but not limited to, latches, hook and loop fasteners, and the like.

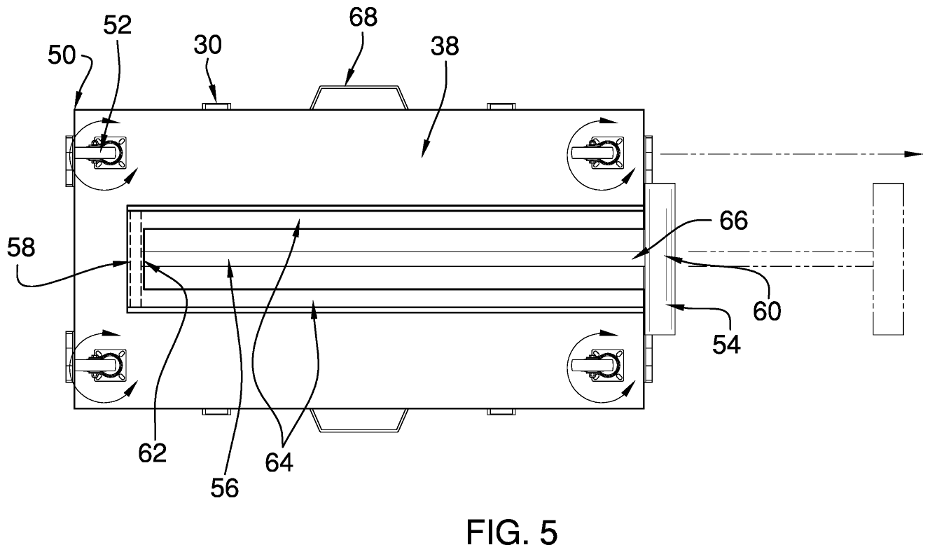

A plurality of wheels 48 is engaged to the bottom 38 of the housing 12. The plurality of wheels 48 may comprise wheels 48 positioned singly proximate to each corner 50 of the bottom 38, or other configurations of wheels 48, such as two wheels 48 positioned on the bottom 38, or three wheels 48 along each opposed side 24 of the housing 12. As shown in FIG. 5, each wheel 48 comprises a castor 52.

A pull handle 54 is engaged to and is selectively extensible from the housing 12. The pull handle 54 is configured to be grasped in a hand of a user, positioning the user to pull on the pull handle 54 to locomote the housing 12 across a surface. The pull handle 54 may comprise a first rod 56, a bar 58, and a second rod 60. The bar 58 is engaged to a first end 62 of the first rod 56. The bar 58 is slidably engaged to and extends between a pair of rails 64, which is engaged to the bottom 38 of the housing 12. The second rod 60 is engaged to a second end 66 of the first rod 56. The first rod 56 is extensible from the housing 12 upon grasping and pulling upon the second rod 60. The present invention anticipates the pull handle 54 being extensible from the housing 12 by other extension means, such as, but not limited to, by comprising a plurality of nested section, an articulating arm, or the like.

Each of a pair of side handles 68 is engaged to a respective opposed side 24 of the housing 12. The side handles 68 are configured to be grasped in hands of the user, positioning the user for lifting the housing 12. The present invention also anticipates the side handles 68 being hingedly engaged to the housing 12.

A top handle 70 is rotationally engaged to one of the covers 14. A catch 72 is engaged to the other of the covers 14. The catch 72 is positioned to selectively engage the top handle 70 as the top handle 70 is rotated so that the top handle 70 is engaged to and extends between the covers 14.

In use, the animal containment and transport assembly 10 enables a method 74 of containing and transporting an animal. The method 74 comprises a first step 76 of providing an animal containment and transport assembly 10 according to the specification above. A second step 78 of the method 74 is disengaging the second fasteners 28 from 15 the first fasteners 26. A third step 80 of the method 74 is hinging the covers 14 open. A fourth step 82 of the method 74 is positioning an animal in the housing 12. A fifth step 84 of the method 74 is hinging the covers 14 closed so that the second fasteners 28 engage the first fasteners 26. A sixth step 86 of the method 74 is extending the pull handle 54 from the housing 12. A seventh step 88 of the method 74 is locomoting the 20 housing 12 and the animal across a surface by pulling on the pull handle 54.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An animal containment and transport assembly comprising;
a housing, a top of the housing being open, the housing having opposed ends, the housing being elongated between the opposed ends;
a pair of covers hingedly engaged to the housing, such that the covers are positioned for selectively closing the top, such that the housing and the pair of covers define an interior space configured for containing an animal; the covers being selectively engageable to the housing, such that the covers are fixedly positioned over the top, wherein each cover is hingedly engaged to a respective one of the opposed ends of the housing;
a plurality of wheels engaged to a bottom of the housing; and
a pull handle engaged to and selectively extensible from the housing, wherein the pull handle is configured for grasping in a hand of a user, positioning the user for pulling on the pull handle for locomoting the housing across a surface.

2. (canceled)

3. The animal containment and transport assembly of claim 1, wherein:
the housing is substantially rectangular cuboid shaped; and
the pair of covers is substantially rectangular frustum shaped when closed over the top.

4. The animal containment and transport assembly of claim 3, wherein opposing end facets of the pair of covers are concavely arcuate when viewed front the interior space.

5. The animal containment and transport assembly of claim 1, further including a plurality of apertures positioned in the pair of covers, wherein the apertures are configured for venting the interior space.

6. The animal containment and transport assembly of claim 1, further including:
a plurality of first fasteners engaged to the housing; and
a plurality of second fasteners engaged to the pair of covers, the second fasteners being complementary to the first fasteners, such that each second fastener selectively engages a respective first fastener as the covers are hinged closed for fixedly engaging the pair of covers to the housing.

7. The animal containment and transport assembly of claim 6, wherein the second fastener and the respective first fastener comprise a latch closure.

8. The animal containment and transport assembly of claim 1, further including:
an opening positioned in a respective opposed end of the housing; and
a screen slidably engaged to the housing, such that the screen is positioned for selectively covering the opening.

9. The animal containment and transport assembly of claim 8, wherein the screen is extensible from the bottom of the housing toward the top of the housing.

10. The animal containment and transport assembly of claim 8, further including:
a first connector engaged to the housing; and
a second connector engaged to the screen, such that second connector is positioned for selectively engaging the first connector upon extension of the screen over the opening for retaining the screen in position over the opening.

11. The animal containment and transport assembly of claim 10, wherein:
the second connector comprises a ring; and
the first connector comprises a hook.

12. The animal containment and transport assembly of claim 1, wherein the plurality of wheels comprises wheels positioned singly proximate to each corner of the bottom,

13. The animal containment and transport assembly of claim 1, wherein each wheel comprising a castor.

14. The animal containment and transport assembly of claim 1, wherein the pull handle comprises:
a first rod;
a bar engaged to a first end of the first rod, the bar being slidably engaged to and extending between a pair of rails engaged to the bottom of the housing; and
a second rod engaged to a second end of the first rod, such that the first rod is extensible from the housing upon grasping and pulling upon the second rod.

15. The animal containment and transport assembly of claim 1, further including a pair of side handles, each side handle being engaged to a respective opposed side of the housing, wherein the side handles are configured for grasping in hands of the user, positioning the user for lifting the housing.

16. The animal contairnment and transport assembly of claim I, further including:
a top handle rotationally engaged to one of the covers; and
a catch engaged to the other of the covers, such that the catch is positioned for selectively engaging the top handle as the top handle is rotated, such that the top handle is engaged to and extends between the covers.

17. A method of containing and transporting an animal, the method comprising the steps of:
providing an animal containment and transport assembly comprising;
a housing, a top of the housing being open, the housing having opposed ends, the housing being elongated between the opposed ends,
a pair of covers hingedly engaged to the housing, such that the covers are positioned for selectively closing the top, such that the housing and the pair of covers define an interior space configured for containing an animal, wherein each cover is hingedly engaged to a respective one of the opposed ends of the housing. a plurality of first fasteners engaged to the housing; and
a plurality of second fasteners engaged to the pair of covers, the second fasteners being complementary to the first fasteners, such that each second fastener selectively engages a respective first fastener as the covers are hinged closed for fixedly engaging the pair of covers to the housing,
a plurality of wheels engaged to a bottom of the housing, and
a pull handle engaged to and selectively extensible from the housing, wherein the pull handle is configured for grasping in a hand of a user, positioning the user for pulling on the pull handle for locomoting the housing across a surface;
disengaging the second fasteners from the first fasteners;
hinging the covers open;
positioning an animal in the housing;
hinging the covers closed so that the second fasteners engage the first fasteners;
extending the pull handle from the housing; and
locomoting the housing and the animal across a surface by pulling on the pull handle.

18. An animal containment and transport assembly comprising;
a housing, a top of the housing being open, the housing having opposed ends, the housing being elongated between the opposed ends, the housing being substantially rectangular cuboid shaped;
a pair of covers hingedly engaged to the housing, such that the covers are positioned for selectively closing the top, such that the housing and the pair of covers define an interior space configured for containing an animal, the covers being selectively engageable to the housing, such that the covers are fixedly positioned over the top, wherein each cover is hingedly engaged to a respective one of the opposed ends of the housing, the pair of covers being substantially rectangular frustum shaped when closed over the top, opposing end facets of the pair of covers being concavely arcuate when viewed from the interior space;
a plurality of apertures positioned in the pair of covers, wherein the apertures are configured for venting the interior space;
a plurality of first fasteners engaged to the housing;
a plurality of second fasteners engaged to the pair of covers, the second fasteners being complementary to the first fasteners, such that each second fastener selectively engages a respective first fastener as the covers are hinged closed for fixedly engaging the pair of covers to the housing, the second. fastener and the respective first fastener comprising a latch closure;
an opening positioned in a respective opposed end of the housing;
a screen slidably engaged to the housing, such that the screen is positioned for selectively covering the opening, the screen being extensible from a bottom of the housing toward the top of the housing;
a first connector engaged to the housing;
a second connector engaged to the screen, such that second connector is positioned for selectively engaging the first connector upon extension of the screen over the opening for retaining the screen in position over the opening, the second connector comprising a ring, the first connector comprising a hook;
a plurality of wheels engaged to the bottom of the housing, the plurality of wheels comprising wheels positioned singly proximate to each corner of the bottom, each wheel comprising a castor;
a pull handle engaged to and selectively extensible from the housing, wherein the pull handle is configured for grasping in a hand of a user, positioning the user for pulling on the pull handle for locomoting the housing across a surface, the pull handle comprising:
a first rod, a bar engaged to a first end of the first rod, the bar being slidably engaged to and extending between a pair of rails engaged to the bottom of the housing, and
a second rod engaged to a second end of the first rod, such that the first rod is extensible from the housing upon grasping and pulling upon the second rod;
a pair of side handles, each side handle being engaged to a respective opposed side of the housing, wherein the side handles are configured for grasping in hands of the user, positioning the user for lifting the housing;
a top handle rotationally engaged to one of the covers; and
a catch engaged to the other of the covers, such that the catch is positioned for selectively engaging the top handle as the top handle is rotated, such that the top handle is engaged to and extends between the covers,
